(19) United States
(12) Patent Application Publication
(10) Pub. No.: US 2014/0182414 A1
(43) Pub. Date: Jul. 3, 2014

(54) STEEL FOR INDUCTION HARDENING AND CRANKSHAFT MANUFACTURED BY USING THE SAME

(71) Applicants: Kisung Kim, Chiyoda-ku (JP); Hiroaki Tahira, Chiyoda-ku (JP); Kaori Kawano, Chiyoda-ku (JP); Koji Watari, Chiyoda-ku (JP)

(72) Inventors: Kisung Kim, Chiyoda-ku (JP); Hiroaki Tahira, Chiyoda-ku (JP); Kaori Kawano, Chiyoda-ku (JP); Koji Watari, Chiyoda-ku (JP)

(73) Assignee: NIPPON STEEL & SUMITOMO METAL CORPORATION, Tokyo (JP)

(21) Appl. No.: 14/235,105

(22) PCT Filed: Jul. 4, 2012
(86) PCT No.: PCT/JP2012/067102

§ 371 Date: Jan. 27, 2014

(30) Foreign Application Priority Data
Jul. 28, 2011 (JP) 2011-165899

(51) Int. Cl. F16C 3/06; C22C 38/00; C22C 38/04; C22C 38/02; C22C 38/28; C22C 38/06

(52) U.S. Cl. CPC F16C 3/06; C22C 38/28; C22C 38/06; C22C 38/04; C22C 38/02; C22C 38/002; C22C 38/001
USPC 74/595; 420/104; 420/84

(57) ABSTRACT

There is provided an induction hardening steel excellent in quenching crack resistance. The induction hardening steel of the present embodiment includes, by mass percent, C: 0.35 to 0.6%, Si: at least 0.01% and less than 0.40%, Mn: 1.0 to 2.0%, S: more than 0.010% and at most 0.05%, Cr: 0.01 to 0.5%, Al: 0.001 to 0.05%, N: Ti/3.4 to 0.02%, and Ti: 0.005 to 0.05%, the balance being Fe and impurities, and satisfies the following formula (1):

2S-3Ti<0.040 (1)

where, into each element symbol in formula (1), the content (mass %) of the corresponding element is substituted.

### TECHNICAL FIELD

The present invention relates to a steel for induction hardening and a crankshaft manufactured by using the steel for induction hardening.

### BACKGROUND ART

Engine parts such as a crankshaft are required to have high wear resistance and high fatigue strength. To enhance the wear resistance and fatigue strength, induction hardening may be performed for engine parts. Consequently, a steel for induction hardening is used for engine parts. The steel for induction hardening have been disclosed in, for example, JP2009-41046A, JP2010-144226A, and JP9-235654A.

In induction hardening, quenching cracks attributable to residual stress may occur. Accordingly, the steel for induction hardening is required to have quenching crack resistance.

Techniques for suppressing cracking of the steel for induction hardening have been proposed in JP5-25546A, JP2004-76086A, and JP2005-256134A.

JP5-25546A describes a method for manufacturing a part that has an excellent torsional strength with quenching cracks being prevented. Specifically, it describes that, among others, the ratio t/r of effective hardened depth t on account of induction hardening—tempering to part radius r is made 0.4 to 0.8, and a cross-sectional average hardness HVa is made 550 or higher.

JP2004-76086A describes a high-strength steel part capable of reliably improving the delayed fracture characteristics even if the steel part has a wide chemical composition. Specifically, it describes that, for example, the content of fine TiC having a grain size of 0.1 μm or smaller is 0.01%, and the ratio TiC/Ti of the content of the fine TiC to the content of total Ti is 0.4 or higher.

JP2005-256134A describes a steel for induction hardening in which grinding cracks are not produced even if grinding is performed after induction hardening or low-temperature tempering has been carried out and a crankshaft by using this steel for induction hardening. Specifically, it describes a steel for induction hardening in which the number of MnS in steel in the longitudinal cross section after rolling is 300/mm² or smaller, and the longitudinal shrinkage amount in differential thermal expansion test is 15 μm or smaller, and the like.

### DISCLOSURE OF THE INVENTION

JP5-25546A describes that the ratio t/r of effective hardened depth t on account of induction hardening—tempering to part radius r is made 0.8 or lower to prevent quenching cracks. It is, however, more desirable to have a technique capable of improving the quenching crack resistance without restricting the ratio of effective hardened depth t to part radius r.

JP2004-76086A assumes the good use of TiC formed by high-temperature tempering. Therefore, this technique cannot be applied to a general induction hardened part subjected to low-temperature tempering.

The steel material described in JP2005-256134A aims at the suppression of grinding cracks. Specifically, the heat generated by grinding after induction hardening—tempering is taken into consideration, and the shrinkage amount in that temperature range is reduced. The grinding cracks and the quenching cracks are fracture modes in different stress states. Therefore, it is unknown whether or not the steel material described in JP2005-256134A has an excellent quenching crack resistance.

Of the crankshafts, a large-sized crankshaft used for trucks and the like is required to have further high wear resistance and fatigue strength as compared with a crankshaft having an ordinary size used for passenger cars and the like. Therefore, the quench hardened layer of the large-sized crankshaft is formed deeper as compared with the crankshaft having an ordinary size used for passenger cars and the like. In order to deepen the quench hardened layer, the large-sized crankshaft is heated for a long period of time with an output higher than the ordinary one.

Therefore, in the case of the steel for induction hardening used for such a large-sized crankshaft, it is rather desirable that the occurrence of quenching cracks is suppressed even if induction hardening, in which heating is performed for a long period of time with a high output, is carried out.

An objective of the present invention is to provide a steel for induction hardening excellent in quenching crack resistance and a crankshaft manufactured by using the steel for induction hardening.

The steel for induction hardening in accordance with one embodiment of the present invention comprising, by mass percent, C: 0.35 to 0.6%, Si: at least 0.01% and less than 0.40%, Mn: 1.0 to 2.0%, S: more than 0.010% and at most 0.05%, Cr: 0.01 to 0.5%, Al: 0.001 to 0.05%, N: T/3.4 to 0.02%, and Ti: 0.005 to 0.05%, the balance being Fe and impurities, and satisfies formula (1):

2S-3Ti<0.040 (1)

where, into each element symbol in formula (1), the content (mass %) of the corresponding element is substituted.

In the above-described steel for induction hardening, in place of some of Fe, Ca: at most 0.005% may be contained.

The crankshaft in accordance with one embodiment of the present invention is manufactured by induction hardening the above-described steel for induction hardening.

According to the present invention, there can be provided a steel for induction hardening excellent in quenching crack resistance and a crankshaft manufactured by using the steel for induction hardening.

### BRIEF DESCRIPTION OF DRAWINGS

FIG. 1 is a graph showing the relationship between the value of the parameter 2S-3Ti specified in the embodiment of the present invention and the crack critical stress defined in the embodiment of the present invention.

FIG. 2 is a schematic view showing the test condition of crack critical stress measurement.

### DESCRIPTION OF EMBODIMENTS

An embodiment of the present invention will now be described in detail. Hereunder, “%” representing the content of each element means “mass percent”.

The present inventors conducted examinations and studies to improve the quenching crack resistance of the steel for induction hardening. As the result, the present inventors obtained the following findings:

(A) The steel for induction hardening is required to have high machinability. Such a steel for induction hardening has a high content of sulfur (S) to enhance the machinability. Sulfur forms sulfide-base inclusions such as MnS among others, thereby enhancing the machinability of steel. However, the sulfide-base inclusions are softer than the base metal (matrix). For this reason, the sulfide-base inclusion is more likely to be the starting point of quenching crack. Therefore, the quenching crack resistance is improved with the decrease in S content.

(B) As described above, in order to deepen the quench hardened layer of a large-sized crankshaft for trucks and the like, it is preferable that the output of high frequency be increased, and the heating time be lengthened. However, if the output of high frequency is increased and the heating time is lengthened, a portion having a low heat capacity of the crankshaft is overheated, and the crystal grains in this portion are coarsened. If the crystal grains are coarsened, the quenching crack resistance decreases.

In order to restrain the coarsening of crystal grains, titanium (Ti) is effective. Titanium forms nitrides and/or carbo-nitrides, and restrains the coarsening of crystal grains by means of the pinning effect. The Ti nitrides and/or Ti carbo-nitrides remain in the steel even at high temperatures. Therefore, the pinning effect can be achieved at high induction hardening temperatures.

In the case where the induction hardening temperature is low, vanadium (V) also forms VC and brings about the pinning effect. However, in the case where the steel for induction hardening is overheated, especially in the case where the induction hardening temperature is 1000° C. or higher, VC dissolves in the steel. Therefore, the pinning effect brought about by VC is not maintained. On the other hand, the Ti nitrides and/or Ti carbo-nitrides are not dissolved in the steel even if the induction hardening temperature becomes 1000° C. or higher, and maintain the pinning effect. For the steel for induction hardening used for large-sized crankshafts, the induction hardening temperature is high, and overheating occurs easily. Therefore, Ti is more liable to maintain the pinning effect as compared with V, and is effective in enhancing the quenching crack resistance.

(C) As described above, the Ti nitrides and/or Ti carbo-nitrides make the crystal grains fine by means of the pinning effect. However, if the content of nitrogen (N) runs short relative to the Ti content, excessive Ti combines with carbon to form TiC. The TiC decreases the quenching crack resistance of steel. Therefore, N of an amount equal or larger than that of Ti is preferably contained. Specifically, the N content is preferably Ti/3.4 or higher.

(D) Further, when the S content and the Ti content satisfy formula (1), the quenching crack resistance enhances remarkably:

2S-3Ti<0.040 (1)

where, into each element symbol in formula (1), the content (mass %) of the corresponding element is substituted.

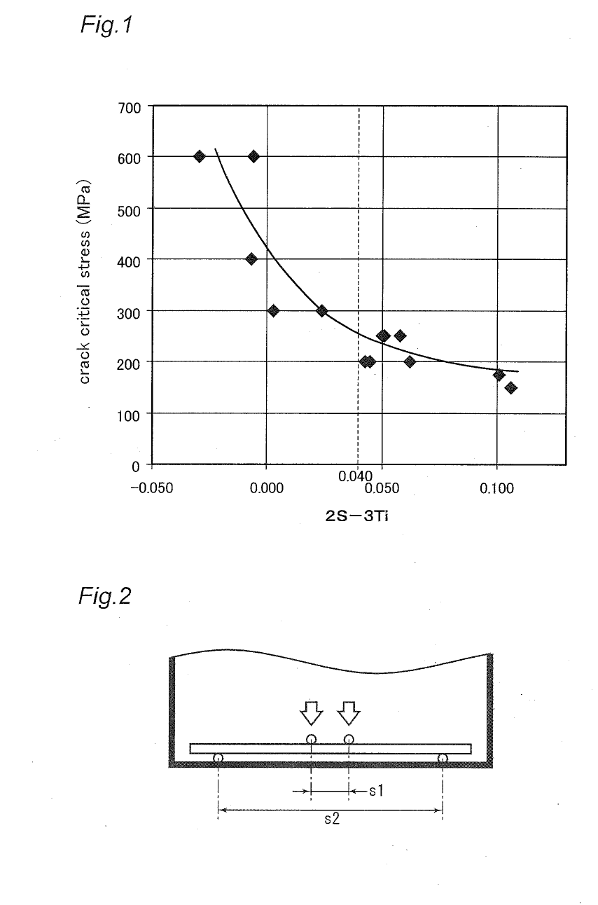

FIG. 1 is a graph showing the relationship between the value on the left-hand side member 2S-3Ti of formula (1) and the crack critical stress defined below. FIG. 1 was obtained by the method described below.

Fifty kilograms of each of steels having various chemical compositions was melted in a vacuum induction heating furnace. From the molten steel, a 100-mm diameter ingot was produced. The ingot was heated to 1250° C. The heated ingot was hot-forged to produce a 60-mm diameter round bar. The forging finishing temperature was 1000° C. The round bar after being hot-forged was allowed to cool to room temperature in the atmosphere.

From the middle position (R/2 position) of the distance R between the central axis and the surface of the round bar after being allowed to cool (that is, the radius), a test specimen was sampled. The size of the test specimen was 10.0 mm×2.0 mm×75.0 mm. The lengthwise direction of the test specimen was parallel to the lengthwise direction of the round bar.

The test specimen was subjected to induction hardening. Specifically, the test specimen was subjected to high-frequency heating at an output of 40 kW and at a frequency of 200 kHz. The hardening temperature was set at 1000° C. The heating time was about 30 seconds. After the heating time had elapsed, the test specimen was cooled rapidly.

As shown in FIG. 2, a bending stress was applied while the induction hardened test specimen was supported at four points. The distance s1 between two supporting points on the upper surface of test specimen was set to 10 mm, and the distance s2 between two supporting points on the lower surface thereof was set to 60 mm. The stress was measured by affixing a strain gage in the center of test specimen, and stress was applied until the stress reaches a predetermined value. The test specimen having been subject to bending stress was immersed in a hydrochloric acid aqueous solution of 0.3 mol/liter for 24 hours. Thereafter, the test specimen was taken out of the hydrochloric acid aqueous solution, and the presence of cracks was checked.

The test was conducted with a plurality of levels of bending stresses, and the maximum bending stress at which no crack was generated was defined as a crack critical stress. Based on the obtained crack critical stress and the parameter 2S-3Ti, FIG. 1 was prepared.

As shown in FIG. 1, with the decrease in the value of 2S-3Ti, the crack critical stress increases. In particular, when the value of 2S-3Ti is not higher than 0.040, the crack critical stress increases suddenly. On the other hand, when the value of 2S-3Ti is not lower than 0.040, the crack critical stress does not increase so much even if the value of 2S-3Ti decreases. In other words, the crack critical stress is a monotone decreasing function of the variable 2S-3Ti, and has an inflection point in the vicinity of the point at which the value of 2S-3Ti is 0.040.

Based on the above-described findings, the present inventors completed the steel for induction hardening in accordance with this embodiment. In the following, the steel for induction hardening in accordance with this embodiment is described in detail.

### [Chemical Composition]

The steel for induction hardening in accordance with this embodiment has the chemical composition described below.

### C: 0.35 to 0.60

Carbon (C) martensitizes the outer layer of steel by means of induction hardening, and increases the hardness of outer layer. On the other hand, if C is contained excessively, the steel hardens excessively, and the machinability of steel decreases. Therefore, the C content is 0.35 to 0.6%. The preferable lower limit of the C content is higher than 0.35%. The upper limit of the C content is preferably less than 0.6%, further preferably 0.5% or less.

Si: at least 0.01% and less than 0.40%

Silicon (Si) deoxidizes the steel. Further, Si strengthens the ferrite. On the other hand, if Si is contained excessively, the machinability of steel decreases. Therefore, the Si content is at least 0.01% and less than 0.40%. The lower limit of the Si content is preferably higher than 0.01%, further preferably at least 0.05%. The preferable upper limit of the Si content is at most 0.30%.

### Mn: 1.0 to 2.0%

Manganese (Mn) enhances the hardenability, and increases the strength and hardness of steel. On the other hand, if Mn is contained excessively, austenite is liable to be retained when hardening is performed. If the retained austenite exists, the mechanical properties of steel degrade. Therefore, the Mn content is 1.0 to 2.0%. The lower limit of the Mn content is preferably higher than 1.0%, further preferably at least 1.2%. The upper limit of the Mn content is preferably less than 2.0%, further preferably at most 1.7%.

S: more than 0.010% and at most 0.05%

Sulfur (S) forms sulfide-base inclusions such as MnS among others, thereby enhancing the machinability of steel. On the other hand, if S is contained excessively, a large number of coarse sulfide-base inclusions are formed. The coarse sulfide-base inclusion becomes the starting point of quenching crack. Therefore, the S content is more than 0.010% and at most 0.05%. The preferable upper limit of the S content is less than 0.05%.

### Cr: 0.01 to 0.5%

Chromium (Cr) increases the hardness of steel. Further, Cr enhances the hardenability of steel. On the other hand, if Cr is contained excessively, bainite is produced. If bainite is produced, the machinability of steel decreases. Therefore, the Cr content is 0.01 to 0.5%. The lower limit of the Cr content is preferably higher than 0.01%, further preferably at least 0.05%. The upper limit of the Cr content is preferably less than 0.5%, further preferably at most 0.35%.

### Ti: 0.005 to 0.05%

Titanium (Ti) deoxidizes the steel. Further, Ti combines with N to form Ti nitrides and/or Ti carbo-nitrides. The Ti nitrides and/or Ti carbo-nitrides make the crystal grains fine due to the pinning effect. If the crystal grains are made fine, the ductility and toughness of steel enhance. For this reason, the quenching crack resistance enhances. On the other hand, if Ti is contained excessively, coarse Ti nitrides, Ti carbo-nitrides, and Ti carbides are formed, and the machinability of steel decreases. Therefore, the Ti content is 0.005 to 0.05%. The lower limit of the Ti content is preferably higher than 0.005%, further preferably at least 0.008%. The upper limit of the Ti content is preferably less than 0.05%, further preferably at most 0.04%.

### Al: 0.001 to 0.05%

Aluminum (Al) deoxidizes the steel. On the other hand, if Al is contained excessively, alumina-base inclusions are formed. The alumina-base inclusions decrease the machinability of steel. Therefore, the Al content is 0.001 to 0.05%. The preferable lower limit of the Al content is higher than 0.001%. The upper limit of the Al content is preferably less than 0.05%, further preferably at most 0.04%.

### N: Ti/3.4 to 0.02%

Nitrogen (N) combines with Ti to form Ti nitrides and/or Ti carbo-nitrides. As described above, the Ti nitrides and/or Ti carbo-nitrides make the crystal grains fine due to the pinning effect, thereby enhancing the quenching crack resistance of steel. If the N content runs short relative to the Ti content, excessive Ti combines with carbon to form TiC. The TiC decreases the machinability of steel. Therefore, N of an amount equal or larger than that of Ti is preferably contained. On the other hand, if N is contained excessively, defects such as voids are easily produced in the steel. Therefore, the N content is Ti/3.4 to 0.02%. Into “Ti” in the “Ti/3.4”, the Ti content is substituted. The value 3.4 is the mass ratio between Ti and N. The preferable lower limit of the N content is higher than Ti/3.4. The preferable upper limit of the N content is less than 0.02%.

The balance of the chemical composition of the steel for induction hardening in accordance with this embodiment consists of Fe and impurities. The impurities in this description mean elements that mixedly enter from ore and scrap used as the raw materials of steel, environments in the production process, or the like.

In this embodiment, vanadium (V) is an impurity. Vanadium combines with C to form VC that has the pinning effect. However, in the case where the induction hardening temperature is high, VC dissolves in the steel. For this reason, the pinning effect due to VC is not achieved. Further, V decreases the machinability of steel. Therefore, in the steel for induction hardening in accordance with this embodiment, V is an impurity.

In this embodiment, boron (B) is an impurity. Boron combines with N to form B nitrides. The B nitrides decrease the cold workability of steel. Therefore, in the steel for induction hardening in accordance with this embodiment, B is an impurity.

### [Concerning Formula (1)]

The chemical composition of the steel for induction hardening in accordance with this embodiment further satisfies the following formula (1):

2S-3Ti<0.040 (1)

where, into each element symbol in formula (1), the content (mass %) of the corresponding element is substituted.

As shown in FIG. 1, with the increase in the ratio of Ti content to S content, the crack critical stress increases gradually, and is increased remarkably by the satisfaction of formula (1). Therefore, the quenching crack resistance of steel is enhanced.

### [Concerning Crystal Grain Size No.]

The steel for induction hardening in accordance with this embodiment contains Ti and N as described above. Therefore, the coarsening of crystal grains is restrained, and excellent quenching crack resistance is attained. The preferable crystal grain size No. of the steel for induction hardening is 5.5 or higher. The crystal grain size No. is defined as described below. A test specimen is sampled from the steel for induction hardening. Of the surface of the sampled test specimen, five arbitrary visual fields are selected. By using the “Reference Chart of Austenite Grain Size for Steel” in JIS G0551, the austenite grain size Nos. in the selected five visual fields are determined. The mean value of the austenite grain size Nos. determined in the five visual fields is defined as the crystal grain size No. of that test specimen.

In the steel for induction hardening in accordance with this embodiment, in place of some of Fe, Ca may be contained.

Ca: at most 0.0050

Calcium (Ca) deoxidizes the steel. Also, Ca spheroidizes inclusions. If inclusions are spheroidized, the stress concentration created by the notch effect is relaxed. For this reason, the quenching crack resistance of steel enhances. On the other hand, if Ca is contained excessively, coarse inclusions are formed, and thereby the quenching crack resistance of steel is decreased. Therefore, the Ca content is at most 0.005%. The preferable upper limit of the Ca content is less than 0.005%.

### [Manufacturing Method]

Explanation is given of one example of the steel for induction hardening in accordance with this embodiment and the method for manufacturing the crankshaft using the steel for induction hardening.

A molten steel having the above-described chemical composition is produced. The molten steel is formed into cast pieces by the continuous casting process. The molten steel may be formed into an ingot by the ingot-making process. The cast piece or the ingot may be hot-worked into a billet or a steel bar.

Next, by hot-forging the cast piece, ingot, billet, or steel bar, an intermediate product having the rough shape of the crankshaft is produced. The produced intermediate product is allowed to cool in the atmosphere. The intermediate product is subjected to induction hardening. As described above, the steel for induction hardening in accordance with this embodiment can be used for a large-sized crankshaft. In the large-sized crankshaft, the quench hardened layer is formed deep. For example, the thickness of the quench hardened layer is 1 mm or larger. For the large-sized crankshaft, the hardening temperature is as high as 950° C. as compared with the crankshaft having the ordinary size used for general passenger cars. Even if induction hardening is performed under such a hardening condition (hardening temperature), the steel for induction hardening in accordance with this embodiment is less liable to be subjected to quenching cracks.

The intermediate product having been induction hardened is subjected to tempering. The tempering process may be omitted. The hardness of the outer layer (the quench hardened layer) of the intermediate product is preferably 600 HV or higher in Vickers hardness.

The intermediate product having been induction hardened (and tempered) is ground into a predetermined shape by machining. By the above-described processes, the crankshaft is manufactured.

### EXAMPLES

Steel bars were produced by hot-forging the steel for induction hardening having various chemical compositions. By using each of the steel bars, the cutting resistance was measured to evaluate the machinability of the induction hardened steel. A test specimen was sampled from the steel bar, and the test specimen was induction hardened. By using the test specimen, the crack critical stress, hardness, and crystal grain size No. were measured to evaluate the quenching crack resistance, hardness, and machinability of the steel for induction hardening, respectively.

### [Preparation of Test Specimen]

Fifty kilograms of each of steels of samples 1 to 5 and samples a to i having the chemical compositions given in Table 1 was melted in a vacuum induction heating furnace. From the melted steel, a 100-mm diameter ingot was produced.

TABLE 1

| | Chemical composition (unit: mass %, balance being Fe and impurities) | | | | | | | | | | | |
|---|---|---|---|---|---|---|---|---|---|---|---|---|
| Sample | C | Si | Mn | S | Cr | Ca | V | Ti | Al | N | Ti/3.4 | 2S − 3Ti |
| 1 | 0.39 | 0.14 | 1.49 | 0.045 | 0.14 | — | — | 0.022 | 0.011 | 0.0128 | 0.0065 | 0.024 |
| 2 | 0.38 | 0.13 | 1.43 | 0.028 | 0.13 | — | — | 0.021 | 0.011 | 0.0128 | 0.0062 | −0.007 |
| 3 | 0.38 | 0.13 | 1.39 | 0.015 | 0.15 | — | — | 0.020 | 0.011 | 0.0127 | 0.0059 | −0.030 |
| 4 | 0.40 | 0.13 | 1.44 | 0.027 | 0.14 | 0.0024 | — | 0.020 | 0.012 | 0.0128 | 0.0059 | −0.006 |
| 5 | 0.45 | 0.14 | 1.42 | 0.028 | 0.13 | — | — | 0.009 | 0.008 | 0.0130 | 0.0026 | 0.029 |
| a | 0.38 | 0.14 | 1.51 | 0.056* | 0.15 | — | — | 0.002* | 0.013 | 0.0136 | 0.0006 | 0.106* |
| b | 0.38 | 0.14 | 1.50 | 0.055* | 0.15 | — | 0.10* | 0.003* | 0.014 | 0.0141 | 0.0009 | 0.101* |
| c | 0.38 | 0.14 | 1.51 | 0.057* | 0.15 | — | 0.10* | 0.023 | 0.017 | 0.0152 | 0.0068 | 0.045* |
| d | 0.39 | 0.56* | 1.45 | 0.067* | 0.13 | — | — | 0.024 | 0.006 | 0.0160 | 0.0071 | 0.062* |
| e | 0.37 | 0.13 | 1.43 | 0.028 | 0.14 | — | — | 0.002* | 0.011 | 0.0128 | 0.0006 | 0.050* |
| f | 0.38 | 0.14 | 1.47 | 0.059* | 0.14 | — | — | 0.025 | 0.017 | 0.0173 | 0.0074 | 0.043* |
| g | 0.45 | 0.15 | 1.43 | 0.042 | 0.13 | — | — | 0.011 | 0.010 | 0.0131 | 0.0032 | 0.051* |
| h | 0.37 | 0.15 | 1.51 | 0.030 | 0.14 | — | — | 0.090* | 0.009 | 0.0160* | 0.0265 | −0.210 |
| i | 0.38 | 0.14 | 1.47 | 0.050 | 0.13 | — | — | 0.014 | 0.011 | 0.0039* | 0.0041 | 0.058* |

In each element (C, Si, Mn, S, Cr, Ca, V, Ti, Al, N) column in Table 1, the content (mass %) of the corresponding element in the chemical composition of each sample is described. The balance excluding the above-described elements in the chemical composition of each sample is Fe and impurities. The symbol “-” in Table 1 indicates that the content of the corresponding element is at an impurity level. In the “Ti/3.4” column, the value obtained by dividing the Ti content by 3.4 is described. In the “2S-3Ti” column, the value on the left-hand side of formula (1) is described.

As shown in Table 1, the chemical compositions of samples 1 to 5 were within the range of the chemical composition of the steel for induction hardening in accordance with this embodiment, and satisfied formula (I).

On the other hand, the chemical compositions of samples a to i did not satisfy at least either one of the chemical composition and formula (1) of the steel for induction hardening in accordance with this embodiment. The symbol “*” described at the right-hand side of the numerical value in Table 1 indicates that the content value is out of the definition range of the steel for induction hardening in accordance with this embodiment.

After having been heated to 1250° C., the ingot was hot-forged to produce a 60-mm diameter round bar. The forging finishing temperature was 1000° C. The round bar after having been hot-forged was allowed to cool to room temperature in the atmosphere.

From the middle position (R/2 position) of the distance R between the central axis and the surface of the round bar, a test specimen was sampled. The size of the test specimen was 10.0 mm×2.0 mm×75.0 mm. The lengthwise direction of the test specimen was parallel to the lengthwise direction of the round bar. From the steel of each sample, a plurality of test specimens were prepared.

Each of the test specimens was subjected to induction hardening. Specifically, the test specimen was subjected to high-frequency heating at an output of 40 kW and at a frequency of 200 kHz. The hardening temperature was set at 1000° C. The heating time was about 30 seconds. After the heating time had elapsed, the test specimen was cooled rapidly.

By using the round bar produced as described above and the test specimen, the cutting resistance, crack critical stress, hardness, and crystal grain size No. were measured.

### [Cutting Resistance]

The cutting resistance (N) was measured by using the round bar before being induction hardened. For the measurement of cutting resistance, a multicomponent tool dynamometer was used. By using a 6-mm diameter carbide coating drill, cutting was performed perpendicularly to the axial direction of the round bar. The circumferential speed was 65 m/min, and the feed speed was 0.22 mm/rev.

### [Crack Critical Stress]

The crack critical stress (MPa) was determined by using the induction hardened test specimen. Specifically, the test specimen of each sample was tested under the same conditions as those in the case where FIG. 1 was prepared.

### [Hardness]

The hardness was measured by using the induction hardened test specimen. Specifically, the test specimen was cut perpendicularly to the major axis direction thereof. The cut surface was mirror polished. The Vickers hardness (HV) based on JIS 22244 was measured at three arbitrary points at a 1-mm depth from the surface of the cut surface having been polished, that is, at three arbitrary points in the central portion of the thickness of 2 mm. The test force was 98N. The mean value of the three obtained Vickers hardnesses was defined as the hardness (HV) of each test specimen.

### [Crystal Grain Size No.]

The induction hardened test specimen was cut perpendicularly to the major axis thereof in the central portion thereof. Five arbitrary visual fields at a 1-mm depth from the surface within the cut surface, that is, in the central portion of the thickness of 2 mm were selected. The austenite grain size Nos. in the five selected visual fields were determined by using the “Reference Chart of Austenite Grain Size for Steel” in JIS G0551. A region surrounded by the prior-austenite grain boundary appearing on account of corrosion produced by a picric acid saturated aqueous solution was recognized as one austenite grain. The mean value of the austenite grain size Nos. determined in the five visual fields was defined as the crystal grain size No. of that test specimen.

### [Test Results]

Table 2 gives the test results. In the “Crack critical stress” column in Table 2, the crack critical stress (MPa) is described. The crack critical stress not higher than 250 MPa was marked with “#”. In the “Hardness” column, the hardness (HV) is described. In the “Crystal grain size No.” column, the crystal grain size No. is described. In the “Cutting resistance” column, the cutting resistance (N) is described. The cutting resistance not lower than 990N was marked with “#”.

TABLE 2

| | Crack critical | Hardness | Crystal grain | Cutting resistance |
|---|---|---|---|---|
| Sample | stress (MPa) | (HV) | size No. | (N) |
| 1 | 300 | 645 | 6.5 | 826 |
| 2 | 400 | 645 | 6 | 858 |
| 3 | 600 | 637 | 6 | 896 |
| 4 | 600 | 659 | 6.5 | 851 |
| 5 | 300 | 690 | 5.5 | 901 |
| a | 150# | 642 | 2.5 | 825 |
| b | 175# | 640 | 3.5 | 994# |
| c | 200# | 649 | 6.5 | 1112# |
| d | 200# | 656 | 6 | 819 |
| e | 250# | 649 | 4 | 860 |
| f | 200# | 641 | 6 | 803 |
| g | 250# | 687 | 5.5 | 980 |
| h | 400 | 648 | 7 | 1151# |
| i | 250# | 650 | 4.5 | 837 |

As described above, each sample was subjected to induction hardening. Therefore, as shown in Table 2, all hardnesses of samples 1 to 5 and samples a to i exceeded 600 HV.

The chemical compositions of samples 1 to 5 were within the range of this embodiment, and satisfied formula (1). Therefore, for samples 1 to 5, the crack critical stress exceeded 250 MPa, and excellent quenching crack resistance was exhibited. Further, the crystal grain size Nos. of samples 1 to 5 were 5.5 or higher. It is thought that excellent quenching crack resistance was exhibited because the coarsening of crystal grains was restrained by Ti nitrides and/or Ti carbo-nitrides, and formula (1) was satisfied. Further, the cutting resistances of samples 1 to 5 were lower than 990N, and excellent machinability was exhibited.

Because containing Ca, sample 4 exhibited a crack critical stress much higher than that of sample 2 having almost the same chemical composition.

On the other hand, for samples a to h, the quenching crack resistance or the machinability was low because the chemical composition and/or the parameter 2S-3Ti for the steel for induction hardening of this embodiment was not satisfied. Specifically, the S content of sample a was too high, and the Ti content thereof was too low. Further, sample a did not satisfy formula (1). Therefore, the crack critical stress was not higher than 250 MPa. Further, the crystal grain size No. was lower than 5.5. The reason for this result is thought to be that the Ti content was too low.

For sample b, the S content was too high, and the Ti content was too low. Further, sample b did not satisfy formula (1). Therefore, the crack critical stress was not higher than 250 MPa, and the crystal grain size No. was lower than 5.5. Further, sample b contained V. Therefore, the cutting resistance was not lower than 990N.

The S content of sample c was too high. Further, sample c did not satisfy formula (1). Therefore, the crack critical stress was not higher than 250 MPa. Further, since sample c contained V, the cutting resistance thereof was not lower than 990N.

The Si content and the S content of sample d were too high. Further, sample d did not satisfy formula (1). Therefore, the crack critical stress was not higher than 250 MPa.

The Ti content of sample e was too low. Further, sample e did not satisfy formula (1). Therefore, the crack critical stress was not higher than 250 MPa, and the crystal grain size No. was lower than 5.5.

The S content of sample f was too high. Further, sample f did not satisfy formula (1). Therefore, the crack critical stress was not higher than 250 MPa.

The chemical composition of sample g was within the range of the chemical composition of the steel for induction hardening in accordance with this embodiment. However, sample g did not satisfy formula (1). Therefore, the crack critical stress was not higher than 250 MPa.

For sample h, the Ti content was too high, and the N content was too low. Therefore, the cutting resistance was not lower than 990N. The reason for this is thought to be that TiC was formed.

The N content of sample i was too low. Therefore, the crack critical stress was not higher than 250 MPa. Also, the crystal grain size No. of sample i was lower than 5.5. The reason for this is thought to be that the N content was too low, and sufficient TiN was not formed.

The above is the explanation of an embodiment of the present invention. The above-described embodiment is merely an illustration for carrying out the present invention. Therefore, the present invention is not limited to the above-described embodiment, and the above-described embodiment can be carried out by being modified as appropriate without departing from the spirit and scope of the present invention.

### INDUSTRIAL APPLICABILITY

The steel for induction hardening in accordance with this embodiment can be used widely for steel materials to be induction hardened. Specifically, it can be used for automotive engine parts and the like. In particular, it can be used for large-sized crankshafts for trucks or the like.

1. A steel for induction hardening comprising, by mass percent, C: 0.35 to 0.6%, Si: at least 0.01% and less than 0.40%, Mn: 1.0 to 2.0%, S: more than 0.010% and at most 0.05%, Cr: 0.01 to 0.5%, Al: 0.001 to 0.05%, N: Ti/3.4 to 0.02%, and Ti: 0.005 to 0.05%, the balance being Fe and impurities, and satisfying the following formula (1):
2S-3Ti<0.040 (1)
where, into each element symbol in formula (1), the content (mass %) of the corresponding element is substituted.

2. The steel for induction hardening according to claim 1, further comprising: in place of some of Fe, Ca: at most 0.005%.

3. A crankshaft manufactured by induction hardening the steel for induction hardening described in claim 1.

4. A crankshaft manufactured by induction hardening the steel for induction hardening described in claim 2.
